(19) United States
(12) Patent Application Publication
(10) Pub. No.: US 2002/0096798 A1
(43) Pub. Date: Jul. 25, 2002

(54) Prefabricated nichos

(76) Inventor: Luciano M. Garcia, Santa Fe, NM (US)

Correspondence Address: Dennis F. Armijo, Esq., DENNIS F. ARMIJO, P.C., Suite 200, 5300 Sequoia Rd., NW, Albuquerque, NM, 87120, US

(21) Appl. No.: 09/767,467

(22) Filed: Jan. 23, 2001

(51) Int. Cl. B28B 1/16

(52) U.S. Cl. 264/132; 264/245; 264/333

(57) ABSTRACT

A prefabricated nicho for insertion into a wall and a method for fabricating the nicho. The preferred nicho is made by applying several layers of plaster materials and lath materials into a mold until the desired thickness is reached. A layer of finish material is then applied. Art moldings and other can be attached to the finished nicho. Different shaped and different sized nichos can be fabricated using appropriately sized molds or frames.

### BACKGROUND OF THE INVENTION

1. Field of the Invention (Technical Field)

The invention relates to an apparatus and method for making prefabricated nichos for interior or exterior use.

2. Background Art

Nichos (nicho is Spanish for niche) are recesses in walls for placement of statues or other items. Normally nichos are constructed on site into a wall. This involves cutting a hole or recess in a portion of the wall and fabricating the nicho by hand in the recess or hole. Although each nicho made by this method is unique, it is very time consuming, expensive, and these types of nichos cannot be mass produced.

Multiple opening precast concrete niches for storing cremation remains are disclosed in U.S. Pat. No. 5,134,758. The multiple openings or box liners are formed from Fibrelyte™ to resemble a marble-like appearance. These box liners are then secured to a table and to each other and a concrete mix is poured over the box liners. Once the concrete is cured the structure is shipped to a site and erected on a foundation. These niches are heavy, cumbersome, and require large equipment for shipping and erection. These niches are not designed to be placed in a wall, but are designed to be a self standing wall. These niches are designed specifically for storage of cremation remains and are constructed to be vandal resistant.

None of the prior art discloses nichos that are precast and made of materials that are relatively light in weight, for residential or building use. Additionally, the prior art does not teach a method of making nichos that can be installed into an existing wall.

### SUMMARY OF THE INVENTION (DISCLOSURE OF THE INVENTION)

In accordance with the present invention, presented is a method and apparatus for prefabricated nichos for placement into walls or freestanding use. The preferred method for fabricating a nicho in a first location for installation of the nicho in a second location comprises the steps of providing a mold for predetermined shape of the nicho, applying a first base coat of plaster to the mold, setting a first lath layer onto the first base coat, applying a second base coat of plaster over the lath layer, setting a second lath layer onto the second base coat, applying a third base coat over the second lath layer, removing a nicho shell from the mold and applying a finish coat to the nicho shell. The preferred method for manufacturing a prefabricated nicho further comprises curing the first base coat, the second base coat and the third base coat each for a predetermined time period. The preferred method for manufacturing a prefabricated nicho further comprises fabricating a footing for the nicho shell. The step of fabricating a footing for the nicho shell comprises forming a footing mold for the desired footing configuration, applying a first base footing coat of plaster into the footing mold, bending the first lath layer onto the first base footing coat of plaster, applying a second base footing coat of plaster onto the first lath layer, bending the second lath layer onto the second base footing coat and applying a third base footing coat onto the second lath layer. The preferred steps of applying a first plaster coat, a second plaster coat, and a third plaster coat each comprise applying uniform thickness of plaster. The step of applying a uniform thickness of plaster comprises applying approximately ¼″ to ⅜″ of plaster. The preferred method for manufacturing a prefabricated nicho can further comprise the step of fabricating a shelf into the nicho shell and applying artistic designs to the nicho shell. The preferred method for manufacturing a prefabricated nicho can further comprise periodically misting the nicho shell prior to the step of applying the finish coat. The step of applying a finish coat can comprise coloring the finish coat and applying a sealer to the nicho shell.

The preferred prefabricated nicho comprises at least two plaster layers in a predetermined nicho shell shape, at least one layer of lath between the at least two plaster layers and a finish coat. The at least two plaster layers preferably each comprise a thickness of ¼″ to ⅜″. The at least two plaster layers comprise a first plaster layer, a second plaster layer, and a third plaster layer, and the at least one lath layer comprises a first lath layer between the first plaster layer and the second plaster layer and a second lath layer between the second plaster layer and the third plaster layer. The first lath layer preferably comprises a metal lath layer and the second lath layer preferably comprises a fiberglass lath layer. The preferred prefabricated nicho can further comprises a footing. The preferred finish coat comprises a colored finish coat and can also comprise a sealer. The preferred prefabricated nicho can further comprises a artistic design on an outside area of the prefabricated nicho.

A primary object of the present invention is to provide a completed prefabricated nicho for insertion into a wall.

Another object of the present invention is to provide a prefabricated nicho for indoor or outdoor use.

Yet another object of the present invention is to provide a nicho that is relatively light in weight and easy to install.

A primary advantage of the present invention is that it can be mass produced.

Another advantage of the present invention is that each nicho can be unique by the addition of different designs of art moldings.

Yet another advantage of the present invention is that it can be easily installed in a new or existing wall.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention, and together with the description, serve to explain the principles of the invention. The drawings are only for the purpose of illustrating a preferred embodiment of the invention and are not to be construed as limiting the invention. In the drawings:

FIG. 1 depicts the preferred wood frame or mold;

FIG. 2 is a side view of FIG. 1;

FIG. 3 is a front view of a nicho showing the each of the layers for constructing a nicho;

FIG. 4 is a cut out view along A-A of FIG. 3;

FIG. 5 is a front view showing the base of the preferred nicho; and

FIG. 6 is a perspective view of a completed nicho.

### DESCRIPTION OF THE PREFERRED EMBODIMENTS (BEST MODES FOR CARRYING OUT THE INVENTION)

The addition of nichos to a home or office enhances the economic and aesthetic value of the building. Nichos have become very popular in the western United States, especially in southwestern style houses and buildings. Nichos are used to exhibit artistic sculptures, religious artifacts or appear as an artistic exhibits themselves. However, as previously stated, prior art nichos are hand made at the site, making the cost of a nicho prohibitive to most persons. Additionally, prior art nichos are heavy and require heavy equipment to install because they are made of precast concrete. The present invention describes a prefabricated nicho and method of making the prefabricated nicho that solves the expensiveness problem and the amount of labor involved in making the prior art nichos.

Additionally, the present invention teaches the use of different types of plasters for fabrication, making the finished nicho lighter and easier to maneuver.

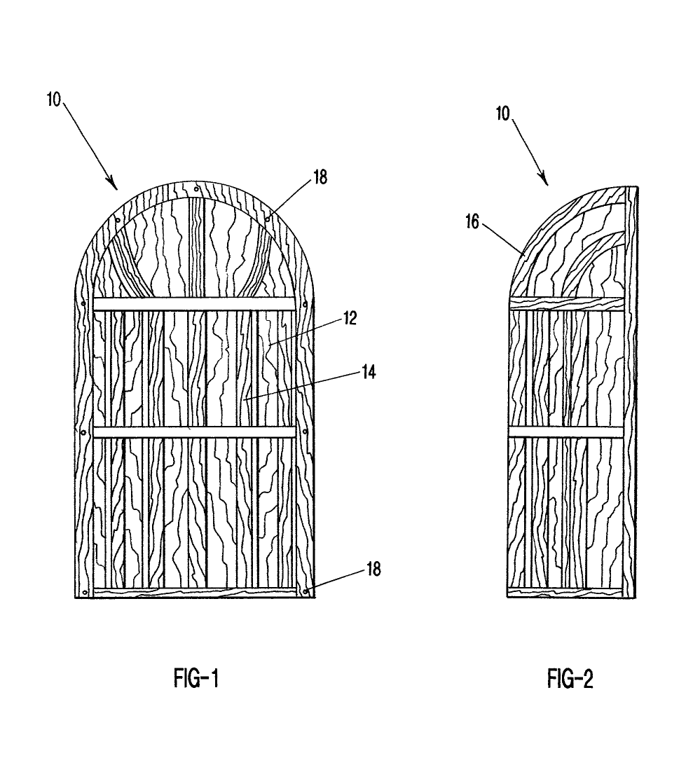

Reference is made to the drawings which illustrate the preferred embodiment of the invention. To begin the process of constructing a nicho, a mold or frame is needed. FIGS. 1 and 2 show the preferred frame 10. Although a wood/mesonate frame is shown, other frames or molds can be used. For example, the mold can be made of a metal such as aluminum, plastic, fiberglass or other well known materials. However, preferably the mold must withstand the nicho making process for more than one unit. Using guidelines of measurements to produce the desired finished size, the nicho wood pattern frame 10 is constructed by attaching mesonate strips 12 to the base 14 and arched cdx plywood studs 16 by use of metal staples and/or screws 18, as shown. Typical measurements for the preferred prefabricated nichos are 14″ wide (W)×24″ high (H)×8″ deep (D) or 16″ W×28″ H×10″ D or 20″ W×36″ H×12″ D. Other shapes and sizes can be used, for example a square or octagonal shaped frame can be constructed. In addition, larger and smaller nicho frames can be made using similar methods.

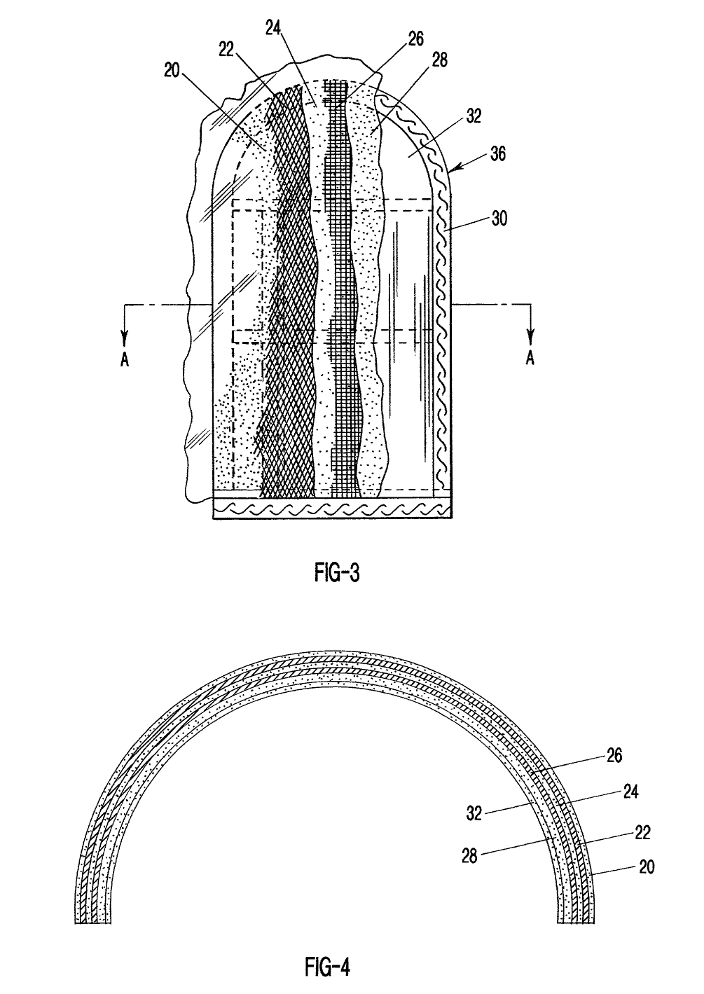

After the mold or frame 10 is fabricated, the process for making the preferred nichos is as follows. A shown in FIGS. 3 and 4, frame 10 is set in the proper position and a material, such as sheet plastic can be placed on the interior of the frame to keep the plaster from sticking to the frame (not shown). If a mold 10 is constructed with a non-stick surface, this step is not necessary. A first base coat plaster layer 20 of approximately ¼″ to ⅜″ thick is then applied over the sheet plastic. The preferred base coat plaster for nichos for interior use can be Structolite™ Fiber Premixed Gypsum Plaster, Red Top™ Gypsum Plaster, Sand Mixed with Imperial™ Base Coat Regular Fiber Plaster, Gold Bond™ Gypsolite mill mix Gypsum Perlite Plaster, or the like. The preferred base coat plaster for nichos for exterior use can be Fast Wall™ concentrate, Western™ fibered gun cement, Sto™ Scratch and brown coat, or the like. Diamond or expanded metal lath 22 is then set onto the first base coat plaster layer 20. The next step comprises waiting approximately 20 minutes for the first base coat plaster layer 20 to dry. A second layer of base coat plaster 24 approximately ¼″ to ⅜″ thick is then applied over the diamond or expanded metal lath 22. A fiberglass mesh 26, such as Sto Mesh 920E is applied over the second layer 24. An approximate drying time of 20 minutes is required for the second layer 24. Next, apply a third coat of plaster material 28 ¼″ to ⅜″ thick over the mesh 26. Finally, the nicho shell 36 should set to dry for 8 to 24 hours. Although three layers of plaster and two layers of lath are disclosed and comprise the preferred embodiment, two layers of plaster and one layer of lath can be used. However, the fewer layers used, the less structural integrity is achieved.

For the finishing process, remove the shell 36 from the frame or mold 10 and stand the nicho shell 36. This begins the curing process that will last 3-4 days depending on humidity conditions. The shell 36 needs a light misting or fogging with clean water every 4 hours.

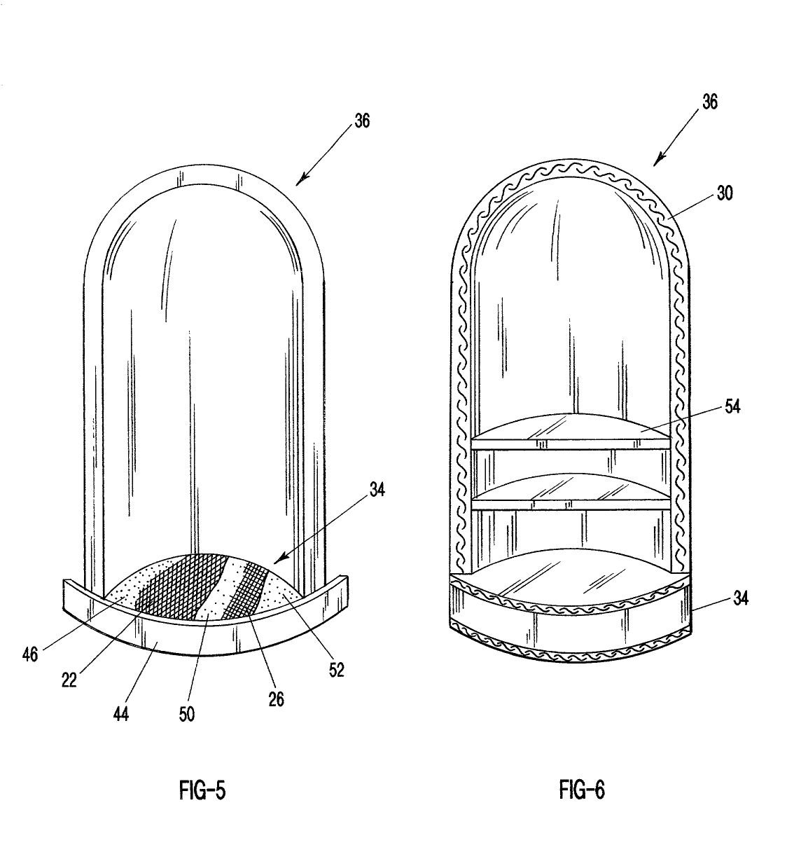

For nichos made using a wood frame 10, the base or footing 34 is then constructed. As shown in FIG. 5, the bottom end of the expanded metal lath 22 is exposed in the fabrication of the shell 36 as well as the bottom end of the fiberglass mesh 26. A curved footing mold 44 is placed in front of the standing shell 36, as shown. The footing mold 44 can be in a semicircular shape, as shown, or in any other shape as desired. The footing 34 is fabricated similarly as the nicho shell 36. A first footing plaster layer 46 is set between the bottom of the nicho shell 48 and the footing mold 44. The bottom end of the metal lath 22 is pulled over the first footing plaster layer 46. The second footing plaster layer 50 is laid over the metal lath 22. The bottom end of the fiberglass mesh 26 is then pulled over the second footing plaster layer 50 and a third footing plaster layer 52 is applied.

Also, after the curing process, the nicho shell 36 is ready for a design 30 to be applied, if a particular design is desired. The design can be carved into the nicho shell or strips of preformed plaster with the desired design can be adhered to the nicho shell. In addition, shelves can be fabricated into the nicho shell using the same process (not shown). Next the finish coat 32 is applied to the shell structure. Apply one finish coat material 38 approximately ⅛″ thick to the nicho shell 36. The preferred finish coating materials for nichos for interior use are Diamond Interior Finish plaster and Structolite Premixed Perlited Gypsum Plaster (non-fibered), Red Top Gypsum Plaster with Celica Sand (non-fibered), Red Top Finish Plaster or Diamond Finish Plaster, or the like. For exterior use nichos, the preferred finish coat comprises Sto Flexyl to prevent cracks and to make the unit waterproof, Sto Primer to improve finish coat adhesion and for waterproofing, and Sto Silco Flex Color Coat. The desired color can be added to the finish coat. A sealer, such as sealer OKON W-1, can be applied. A shelf 54, as shown in FIG. 6 can be added, if desired.

By using the above process, the finished nicho will weigh approximately 30-70 pounds, depending on size. The finished nicho can then be installed into an existing wall using well known techniques similar to the installation of windows or doors.

Although the invention has been described in detail with particular reference to these preferred embodiments, other embodiments can achieve the same results. Variations and modifications of the present invention will be obvious to those skilled in the art, and it is intended to cover in the appended claims all such modifications and equivalents. The entire disclosures of all references, patents, and publications cited above, are hereby incorporated by reference.

What is claimed is:

1. A method for fabricating a nicho in a first location for installation of the nicho in a second location, the method comprising the steps of:
a) providing a mold for predetermined shape of the nicho;
b) applying a first base coat of plaster to the mold;
c) setting a first lath layer onto the first base coat;
d) applying a second base coat of plaster over the lath layer;
e) setting a second lath layer onto the second base coat;
f) applying a third base coat over the second lath layer;
g) removing a nicho shell from the mold; and
h) applying a finish coat to the nicho shell.

2. The method of claim 1 further comprising curing the first base coat, the second base coat and the third base coat each for a predetermined time period.

3. The method of claim 1 further comprising fabricating a footing for the nicho shell.

4. The method of claim 3 wherein the step of fabricating a footing for the nicho shell comprises:
forming a footing mold for the desired footing configuration;
applying a first base footing coat of plaster into the footing mold;
bending the first lath layer onto the first base footing coat of plaster;
applying a second base footing coat of plaster onto the first lath layer;
bending the second lath layer onto the second base footing coat; and
applying a third base footing coat onto the second lath layer.

5. The method of claim 1 wherein the steps of applying a first plaster coat, a second plaster coat, and a third plaster coat each comprise applying uniform thickness of plaster.

6. The method of claim 5 wherein the step of applying a uniform thickness of plaster comprises applying approximately ¼″ to ⅜″ of plaster.

7. The invention of claim 1 further comprising the step of fabricating a shelf into the nicho shell.

8. The method of claim 1 further comprising the step of applying artistic designs to the nicho shell.

9. The method of claim 1 further comprising periodically misting the nicho shell prior to the step of applying the finish coat.

10. The method of claim 1 wherein the step of applying a finish coat comprises coloring the finish coat.

11. The method of claim 1 further comprising applying a sealer to the nicho shell.

12. A prefabricated nicho comprising:
at least two plaster layers in a predetermined nicho shell shape;
at least one layer of lath between the at least two plaster layers; and
a finish coat.

13. The invention of claim 12 wherein said at least two plaster layers each comprise a thickness of ¼″ to ⅜″.

14. The invention of claim 12 wherein said at least two plaster layers comprise a first plaster layer, a second plaster layer, and a third plaster layer, and said at least one lath layer comprises a first lath layer between said first plaster layer and said second plaster layer and a second lath layer between said second plaster layer and said third plaster layer.

15. The invention of claim 14 wherein said first lath layer comprises a metal lath layer and said second lath layer comprises a fiberglass lath layer.

16. The invention of claim 12 further comprises a footing.

17. The invention of claim 12 wherein said finish coat comprises a colored finish coat.

18. The invention of claim 12 further comprising a sealer.

19. The invention of claim 12 further comprises a artistic design on an outside area of said prefabricated nicho.
